(19) United States
(12) Patent Application Publication
(10) Pub. No.: US 2007/0034649 A1
(43) Pub. Date: Feb. 15, 2007

(54) Ergonomic dispenser

(76) Inventors: Scott Edward Smith, Cincinnati, OH (US); Ayub Ibrahim Khan, Cincinnati, OH (US); Terry William Goins, Dayton, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/203,843

(22) Filed: Aug. 15, 2005

(51) Int. Cl. B67D 5/06; B65D 83/00

(52) U.S. Cl. 222/182; 222/402.13

(57) ABSTRACT

A dispenser comprising a container, a functional cover cap, an actuator and a dispenser plate wherein said container comprises a top and a groove wherein said groove comprises a center positioned on the container such that the center of said groove is at least more than about 3% from the top of the container.

### FIELD OF THE INVENTION

The present invention relates to a dispenser, particularly, an enhanced ergonomically designed dispenser to ease dispensing of a product within the container.

### BACKGROUND OF THE INVENTION

Over time there have been a number of designs directed to containers, particularly aerosol containers. Many have been produced utilizing metal, plastic and glass with various shapes and sizes. Fixtures, such as valves, are usually added to help with the safe dispensing of products held within such pressurized vessels. The valve systems also minimize or eliminate accidental release of product when the containers are shipped and/or transported.

Handheld aerosol containers are typically designed with a fixed valve atop the container. The position of the groove and valve directs the hand position of the consumer to the top of the container to necessitate actuation while the actuator is placed in communication to the valve. A cap or covering usually snaps to the top of the can, to the actuator, or to the valve itself to house the valve system and to provide protection against accidental actuation and release of the product. Therefore, it is typical for aerosol cans to have a ring or groove positioned towards the top of the container whereby the cap or actuator snaps into place. Due to the position of the actuator on such cans, consumers may be limited to where they may spray the product relative to their body. Such a can may be difficult to position and actuate at the same time.

Accordingly, the present invention provides for an enhanced ergonomically designed dispenser wherein the ring or snap groove is positioned significantly below the top of the container such that it is able to retain a more ergonomic cap, closure or actuator. Moreover, by positioning the retaining groove toward the center of the container, there is more stability and control in dispensing the product. The actuator can therefore be moved from the top of the container to a more ergonomically pleasing position to provide comfort and ease to the consumer.

### SUMMARY OF THE INVENTION

A dispenser comprising a container, a functional cover cap, an actuator and an orifice plate wherein said container comprises a top and a groove wherein said groove comprises a center position ed on the container such that the center of said groove is at least more than about 3% from the top of the container.

### BRIEF DESCRIPTION OF THE DRAWINGS

While the specification concludes with claims that particularly point out and distinctly claim the invention, it is believed that the present invention will be better understood from the following description of preferred embodiments, taken in conjunction with the accompanying drawings in which:

FIG. 1 is a perspective view of the dispenser of the present invention;

FIG. 2 is a exploded view of the container and valve assembly of the present invention;

FIG. 3 is a cross-sectional view of the container, valve assembly, actuator and functional cover cap of the present invention;

FIG. 4 is an exploded view of the functional cover cap, actuator and orifice plate of the present invention;

FIG. 5 is a cross-sectional side view of the functional cover cap of the present invention;

FIG. 6 is a side view of the actuator of the present invention

FIG. 7 is a cross-sectional side view of the actuator of the present invention;

FIG. 8 is a top view of the actuator of the present invention;

FIG. 9 is an underside view of the orifice plate of the present invention;

FIG. 10 is a top view of the orifice plate of the present invention.

### DETAILED DESCRIPTION OF THE INVENTION

While the specification concludes with the claims particularly pointing and distinctly claiming the invention, it is believed that the present invention will be better understood from the following description.

As used herein, “comprising” means that other steps and/or elements can be added. This term encompasses the terms “consisting of” and “consisting essentially of”. The phrase “consisting essentially of” means that the invention may include additional elements, but only if the additional elements do not materially alter the basic and novel characteristics of the claimed invention or methods.

The present invention provides for a dispenser comprising a container comprising a snap groove particularly engineered in relation to the top of the container to provide for an enhanced ergonomically designed dispensing device. The container, functional cover cap, actuator and orifice plate of the present invention interact with each other to ease use of the dispenser such that there is dispensing from the orifice plate at the opening of the functional cover cap, i.e., point of product flow, relative to the point of depression or force of a push button.

Through mechanisms described herein, actuators of the present invention can be engaged and thus assembled by a variety of means. The present invention provides for a functional cover cap comprising at least one push button for actuation and an orifice plate for dispensing a product from within the container. For example, the functional cover cap may provide for an actuator wherein two buttons are at least about laterally opposed to each other. When depressed, the product within the container may dispense from at least one orifice on the orifice plate positioned within the functional cover cap. The orifice plate may comprise one or more orifices openings and the plate that may be positioned at any point within the functional cover cap itself. For example, once the actuator is depressed, the product may dispense from about 45°, from about 65°, or an from about 90°, but no more than about 180°, no more than about 120°, or no more than about 105° from an area on the functional cover cap relative to the point of depression. The actuator, i.e. push buttons may be made of a variety of sizes, shapes, textures and materials to aid in the dispensing of the product from the container. The push buttons of the present invention may be made of materials including, but not limited to, plastic, rubber, metal, glass and the like. The container of the present invention may also be made of materials including, but not limited to, plastic, metal, glass, and the like.

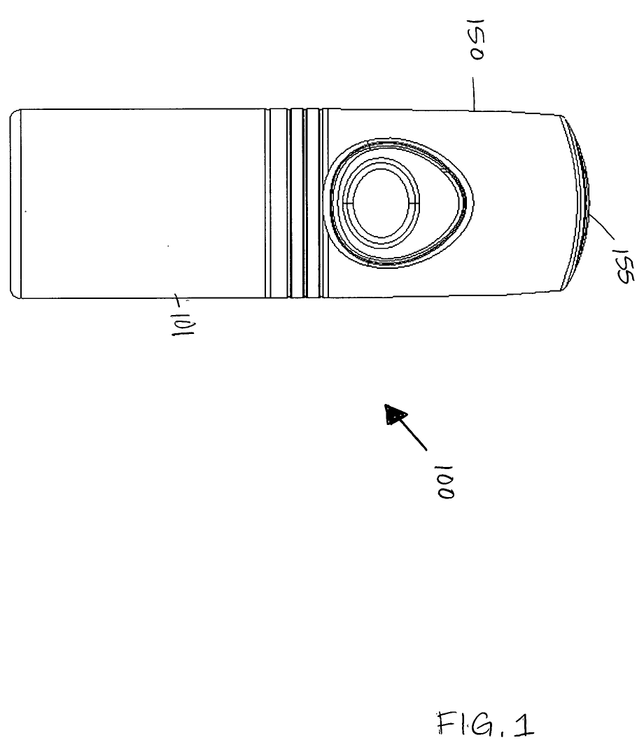

Referring to FIG. 1, a perspective view of a dispenser 100 of the present invention is shown. The container 101 and functional cover cap 150 provide an enhanced ergonomically designed dispensing device. Generally, the dispenser 100 provides a means for dispensing a product from within the container 101 out of an opening within the functional cover cap 155. While the FIGURES provide details of one embodiment of the present invention, one of ordinary skill in the art recognizes that the present invention is not limited to pressurized containers but may also encompass that of a pump dispensing container wherein the container is not pressurized. Below provides the details of each component of the ergonomic dispenser of the present invention.

Container

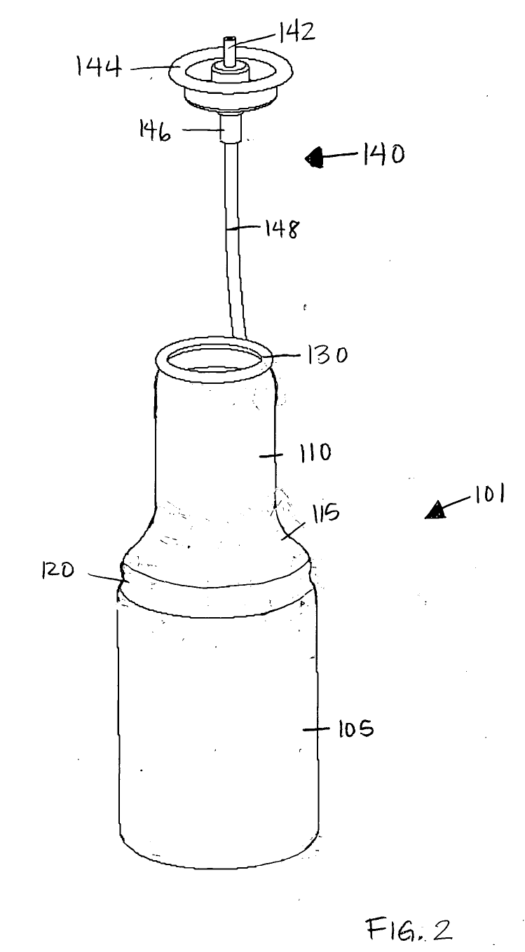

Referring generally to FIG. 2, the container 101 has a bottom portion 105, a top portion 110 and at least one groove 120. If the container 101 is shaped as generally shown in FIG. 2, the top portion of the container may be referred to as the chimney 110 of the container 101. As generally shown, a container 101 wherein a chimney 110 is present, also has a shoulder 115.

The present invention comprises a means for dispensing a product from within the container 101. The means for such may be a pressurized valve assembly 140, as shown generally in FIG. 2. The valve assembly 140 comprises a valve stem 142 positioned perpendicularly within the valve cup 144. A valve housing 146 is positioned at the bottom of the valve cup 144 to connect the dip tube 148 to the valve cup 144. The dip tube 148 sits within the container 101 while the valve cup 144 connects the valve assembly 140 to the container by attaching to the curl or generally, the top 130 of the container 101. Threads (not shown) may also be used to affix the valve assembly 140 to the chimney 110 of the container 101. If the container 101 is made of plastic or glass, however, the container 101 may utilize a bead (not shown) for connecting the valve assembly 140 in place.

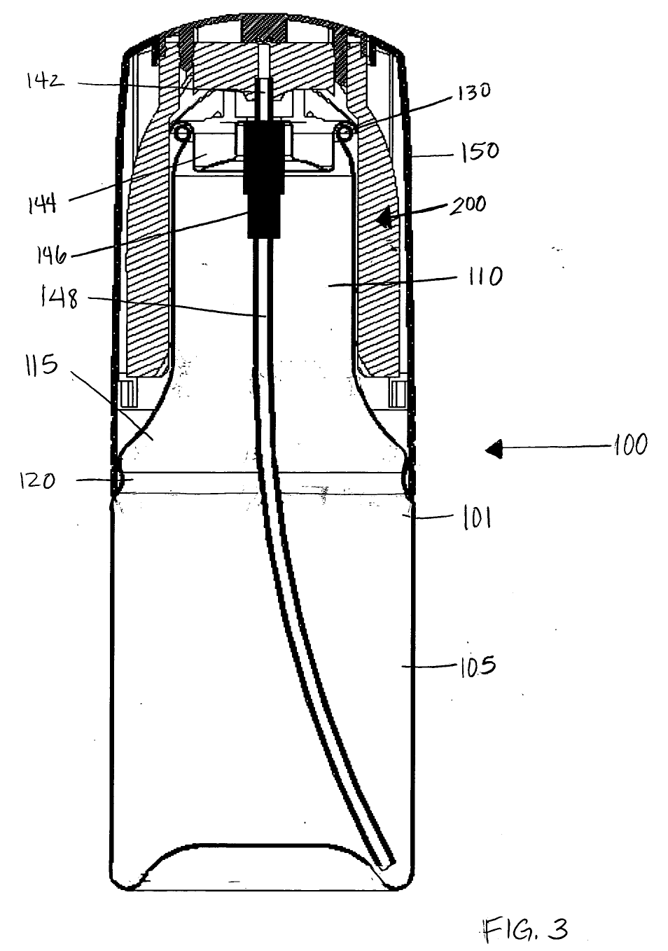

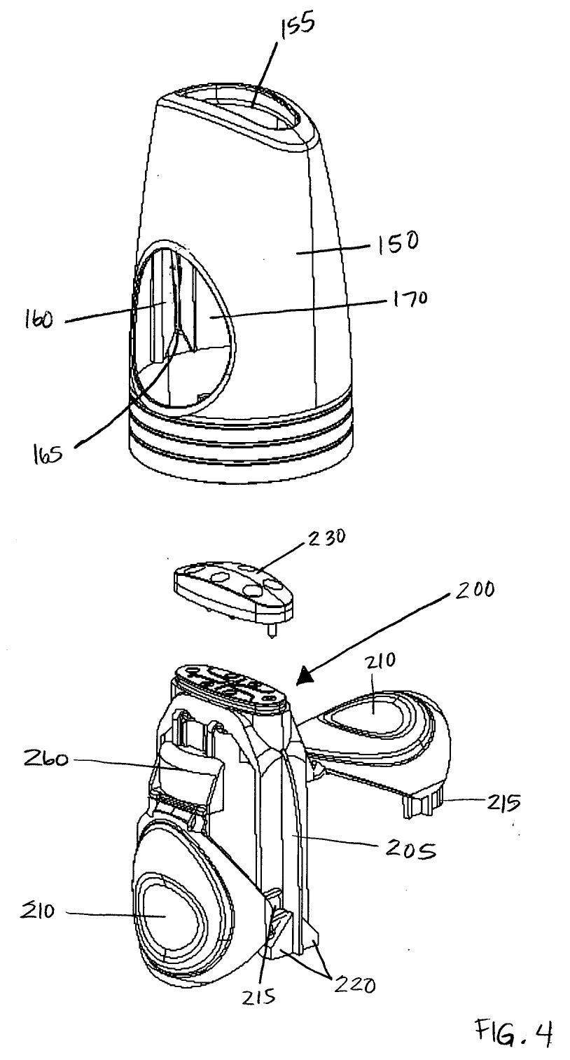

Referring generally to FIG. 3, the container 101 provides for at least one groove 120 that enables a functional cover cap 150 to be held in place to allow for proper actuation. Although the present invention is not limited to a functional cover cap 150, the figures show such an embodiment. Any functional actuating system, however, may be appropriate. The functional cover cap 150 of the present invention houses the actuator 200 and therefore, the groove 120 is positioned advantageously to hold the functional cover cap 150 and to allow the hand to be in a more ergonomically-pleasing position while actuating the contents of the container 101. The force created between the functional cover cap 150 and the groove 120 is such that when the push buttons 210 (FIG. 4) of the actuator 200 are pressed, the functional cover cap 150 is able to hold the elements of the actuator 200 in place. Therefore, the groove 120 should be strategically positioned such that a force is created. It is the relationship of the functional cover cap 150 to the groove 120 of the container 101 that determines the accuracy of actuation. The present invention for example, provides for the groove 120 to be positioned on the container 101 wherein the center of the groove 120 is positioned at least more than about 3%, more than about 5%, more than about 7%, more than about 10%, or more than about 40% (as shown in the figures) from the top or curl 130 of the container 101.

Functional Cover Cap

Referring generally to FIG. 4, the functional cover cap 150 houses the actuator 200 and orifice plate 230 of the present invention. The actuator 200 is held by the functional cover cap by means of guide arms 160 and guide arm channels 165 which may be located within both side walls of the functional cover cap 150. As shown, push button openings 170 may be found on opposite sides of the functional cover cap 150, each located approximately 90° from the guide arms 160 and guide arm channels 165. The present invention, however, is not limited to two push button openings 170 but may also comprise more than two or less than two push button openings 170. The functional cover cap 150 may also be absent of push button openings 170 to allow for sensors (not shown) or other controls for actuation. The contents of the container 101 may be dispensed from the orifice plate 230 positioned in the top opening of the functional cover cap 155. The contents, however, may also be dispensed from alternative locations such as the sides of the functional cover cap 150 or from areas of the container 101. As shown, the means of actuation, such as the push buttons 210 may be positioned at least about 90° from the orifice plate, i.e., point of product flow. The means of actuation, however, may also be positioned at the point of product flow, at about 45° from the point of product flow or at about 180° from the point of product flow.

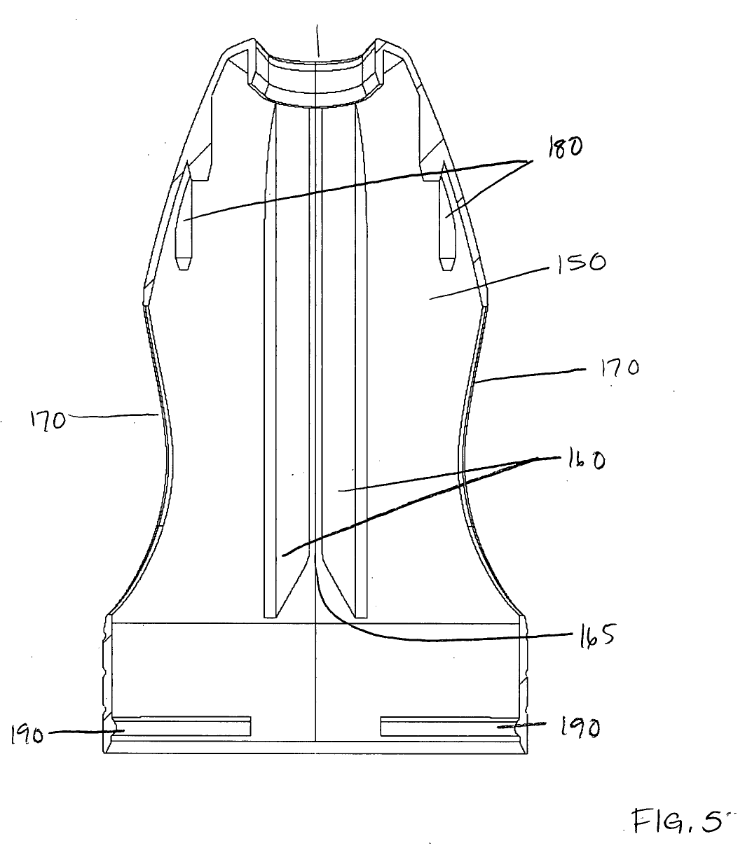

As shown in FIG. 5, the functional cover cap 150 of the present invention further comprises positioning pins 180 that assist in keeping the actuator 200 (FIG. 4) properly positioned. Snap beads 190 are found on the inside lower portion of the functional cover cap 150 which, allow the functional cover cap 150 to be held within the groove 120 (FIG. 3) of the container 101 (FIG. 3). The positioning pins 180 are within the functional cover cap 150 at points relative to the length of the chimney 110 (FIG. 3) and the groove 120 (FIG. 3) of the container 101 (FIG. 3).

Actuator

Referring back to FIG. 4, the actuator 200 of the present invention is housed by the functional cover cap 150 by means of engaging the actuator arms 205 of the actuator 200 into the guide arm channels 165 which, may positioned on both sides of the functional cover cap 150. As generally shown, the push button 210 sits within the push button opening 170 of the functional cover cap 150 while the orifice plate 230 sits within the top opening of the functional cover cap 155. When the push button 210 is depressed, the drivers 215 interact with the lever 220 to adjust the force, enabling the actuator arm 205 to move vertically downward to open the valve assembly 140 (FIG. 2) and dispense the product.

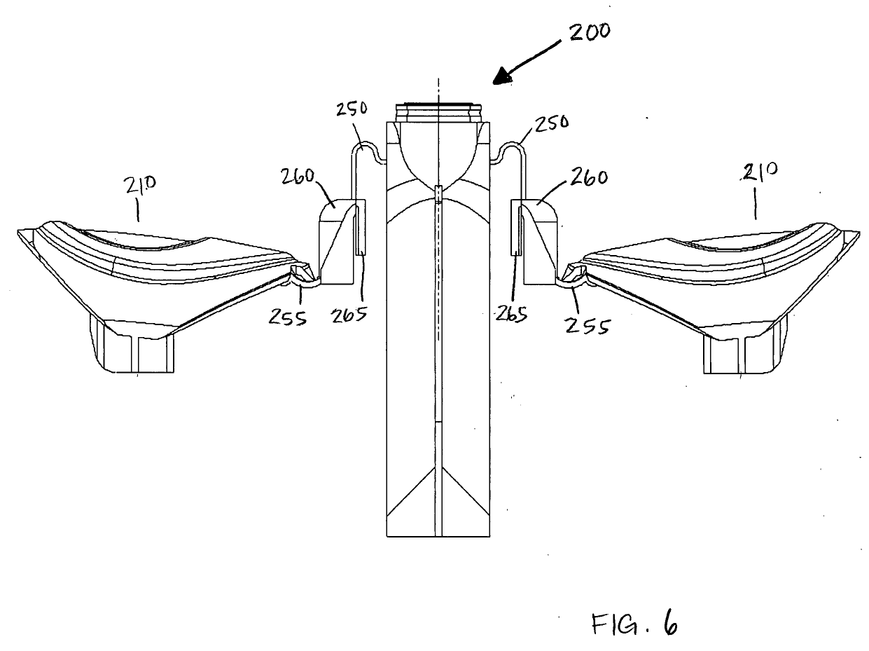

When the functional cover cap 150 is snapped onto the container 101 (FIG. 3) with the actuator 200 housed, at least one positioning pin 180 (FIG. 5) interacts with the actuator 200 by applying force onto the surface of the stabilizer 260. The force allows the actuator arms 205 to move vertically upward when the push buttons 210 are depressed. FIG. 6 shows, generally, a side view of the actuator 200 which allows a viewing of the hooks 265 positioned on the back side of each stabilizer 260. The hooks 265 also aid in positioning the actuator 200 by attaching the actuator 200 atop the valve cup 144 (FIG. 3) or, generally, to the top of the container 101 (FIG. 3), where it is statically held. Once the push buttons 210 are depressed, the spring hinges 255 that are connected to the stabilizer 260 help return the push button 210 to the original starting position so that force may be applied again. Flexible connectors 250, as shown, may connect the stabilizer 260 to the actuator 200 so that the actuator 200 and push buttons 210 are housed as one piece. The present invention, however, is not limited to the presence of flexible connectors 250. The actuator 200 is also able to operate without flexible connectors 250 such that the stabilizer 260 and push buttons 210 are separate pieces.

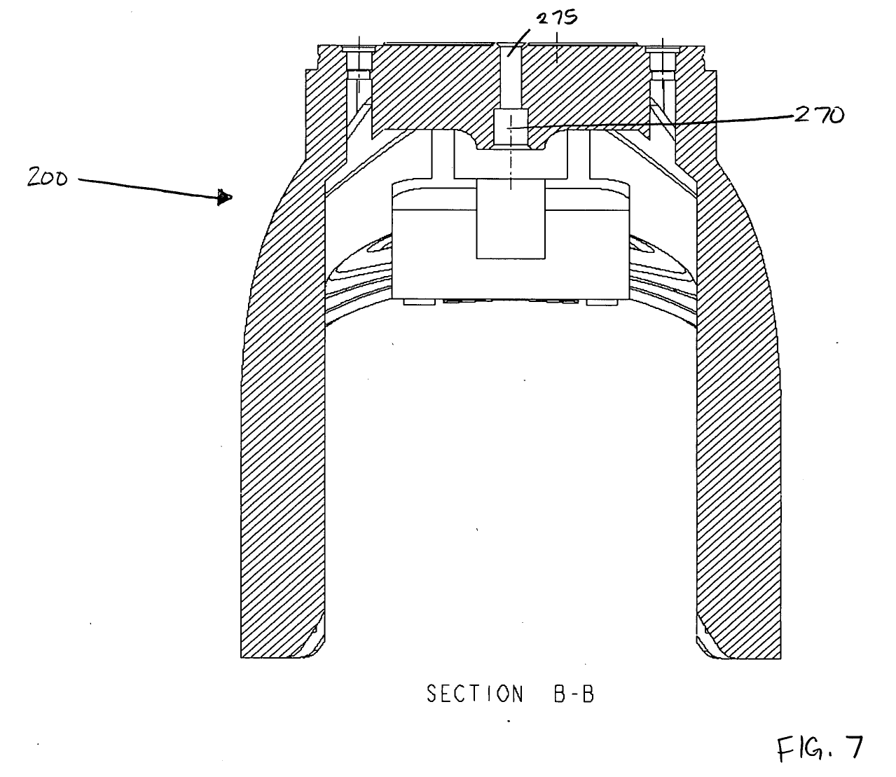

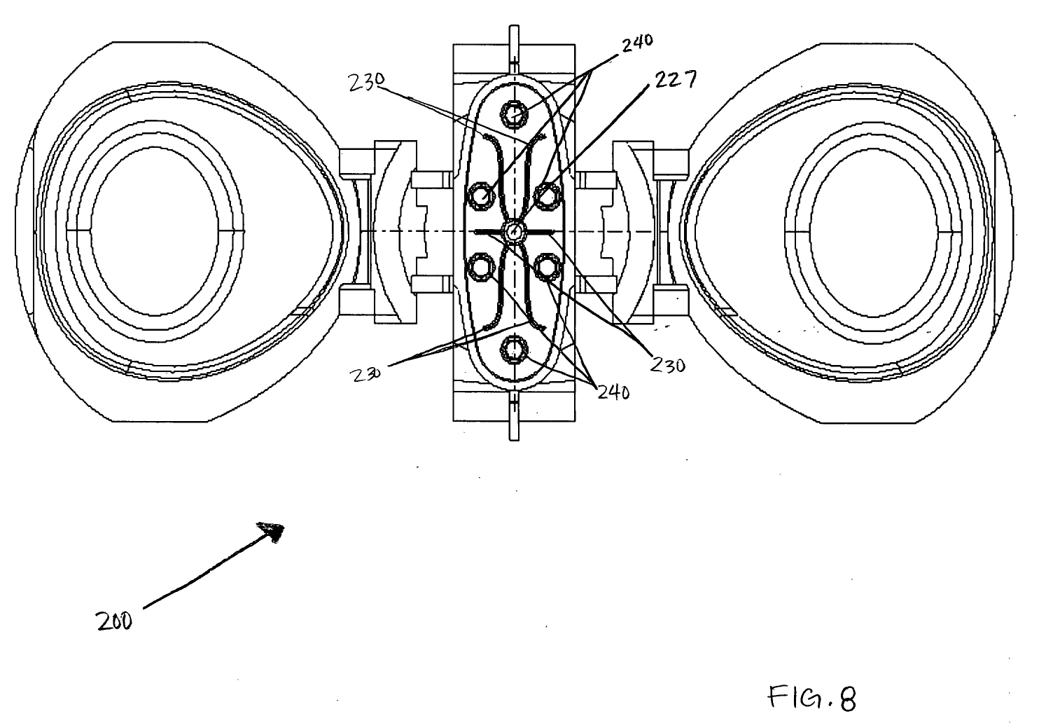

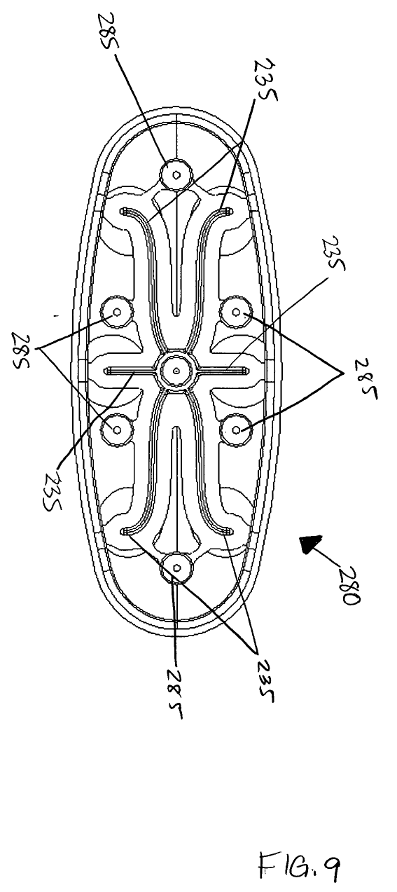

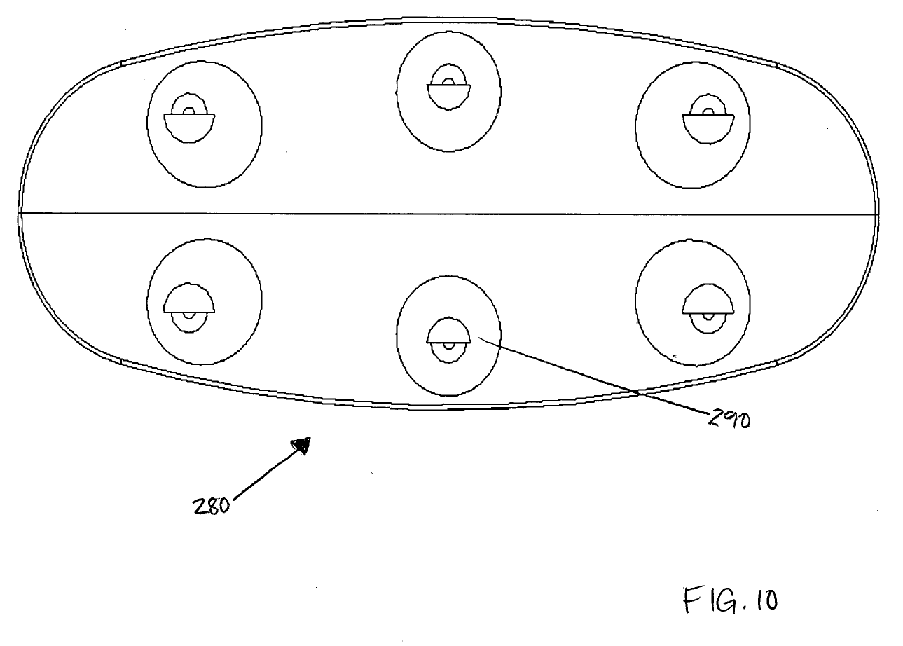

Referring generally to FIG. 7, the actuator 200 further attaches to the valve assembly 140 (FIG. 3) via the valve stem seal 270. Upon actuation, product flows through the valve stem 142 (FIG. 3) and into the product flow channel 275. Referring generally to FIG. 8, the product then flows to the core of the actuator 227, along the diverted flow channel bead 230, and then exits out of the orifice(s) 290 (FIG. 10) via the orifice plate 230 (FIG. 10). FIG. 9, generally, shows the underside of one embodiment of an orifice plate 280 of the present invention. The diverted flow channels 235 shown form a tongue and groove engagement with the diverted flow channel beads 230 (FIG. 8). The orifice plate pins 285 insert into the orifice plate pin holes 240 (FIG. 8) of the actuator 200 (FIG. 8) to secure the orifice plate 280 in place.

While the present invention provides a variety of shapes and number of orifices 290, FIG. 10 shows, generally, the topside of an orifice plate 280 of the present invention wherein six orifices 290 are positioned on the plate 280 as being circular with a conical depression. The number of orifices 290 and the spacing of each opening will be relative to the type of use and the product that may be dispensed. For example, an air fragrance enhancer may comprise only one orifice while a deodorant spray may comprise six or eight orifices.

All documents cited in the Detailed Description of the Invention are, are, in relevant part, incorporated herein by reference; the citation of any document is not to be construed as an admission that it is prior art with respect to the present invention. To the extent that any meaning or definition of a term in this document conflicts with any meaning or definition of the term in a document incorporated herein by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. (canceled)

2. The dispenser of claim 8 wherein the actuator and the dispenser plate are housed by said functional cover cap

3. The dispenser of claim 8 wherein the functional cover cap comprises a top opening and a bottom interior wherein said bottom interior comprises a bead to fit within said second groove of said container.

4. The dispenser of claim 3 wherein the dispenser plate is positioned at the top opening of the functional cover cap.

5. The dispenser of claim 8 wherein the actuator comprises at least one push button.

6. The dispenser of claim 8 wherein the dispenser plate comprises at least one orifice.

7. (canceled)

8. A dispenser comprising:
(a) a container body comprising a first groove proximate the top of said container and a separate and distinct second groove that is distally located from said top of said container;
(b) a functional cover cap that is engaged with said second groove;
(c) an actuator at least partially disposed within said functional cover cap; and
(d) a dispenser plate at least partially disposed within said functional cover cap.

9. The dispenser of claim 8 wherein said top of said container is defined by a curl formed with a terminal portion of said container.

10. The dispenser of claim 8 wherein said second groove is positioned at least more than about 3% of a length of said container away from said top of said container.

11. The dispenser of claim 8 wherein said second groove is positioned at least more than about 5% of a length of said container away from said top of said container.

12. The dispenser of claim 8 wherein said second groove is positioned at least more than about 7% of a length of said container away from said top of said container.

13. The dispenser of claim 8 wherein said second groove is positioned at least more than about 40% of a length of said container away from said top of said container.

14. A dispenser comprising:
(a) a container body comprising a first groove proximate the top of said container and a separate and distinct second groove that is distally located from said top of said container; and
(b) a cover cap that is engaged with said second groove.

15. The dispenser of claim 14 wherein said top of said container is defined by a curl formed with a terminal portion of said container.

16. The dispenser of claim 14 wherein said second groove is positioned at least more than about 3% of a length of said container away from said top of said container.

17. The dispenser of claim 14 wherein said second groove is positioned at least more than about 5% of a length of said container away from said top of said container.

18. The dispenser of claim 14 wherein said second groove is positioned at least more than about 7% of a length of said container away from said top of said container.

19. The dispenser of claim 14 wherein said second groove is positioned at least more than about 40% of a length of said container away from said top of said container.
